(19) United States
(12) Patent Application Publication
(10) Pub. No.: US 2015/0180344 A1
(43) Pub. Date: Jun. 25, 2015

(54) CONTROL DEVICE AND METHOD FOR CHARGING AN ELECTRICAL ENERGY STORE

(71) Applicant: Robert Bosch GmbH, Stuttgart (DE)

(72) Inventors: Karlheinz Lunghard, Buehl (DE); Heiner Jacobs, Baden-Baden (DE); Holger Borst, Heuweiler (DE); Bertram Schillinger, Buehl (DE); lngo Dwertmann, Heilbronn (DE); Heinz Waeldele, Offendorf (FR)

(21) Appl. No.: 14/413,951

(22) PCT Filed: Jul. 4, 2013
(86) PCT No.: PCT/EP2013/064160

§ 371 Date: Jan. 9, 2015

(30) Foreign Application Priority Data
Jul. 13, 2012 (DE) 10 2012 212 262.1

(51) Int. Cl. H02M 3/335

(52) U.S. Cl. CPC H02M 3/33507

(57) ABSTRACT

The invention relates to a control device (100) for charging an electrical energy store (T5), comprising: a network filter device (T1), which is designed to limit electrical interferences of an input AC voltage (U1); a power rectifier circuit device (T2), which is coupled to the network filter device (T1) and is designed to convert the input AC voltage (U1) into a rectified input voltage (U2); a full bridge device (T3) which is coupled to the power rectifier circuit device (T2) and is designed to convert the rectified input voltage (U2) into a high-frequency AC voltage (U3); a transformer device (TRF 1), which is coupled to the full bridge device (T3) and is designed to convert the high-frequency AC voltage (U3) into a transformed AC voltage (U4); a rectifier circuit device (T4) which is coupled to the transformer device (TRF1) and is designed to convert the transformed AC voltage (U4) into a rectified output voltage (U5); and an output choke (DL1) which is coupled to the rectifier circuit device (T4) and is designed to filter the rectified output voltage (U5) in order, thereby, to charge the electrical energy store (T5).

### BACKGROUND OF THE INVENTION

The invention relates to a control device and a method for charging an electrical energy store.

The German patent publication DE 3 612 906 A1 describes a power supply unit for converting a mains AC voltage into at least one DC voltage without using a transformer and using at least one rectifier circuit. At least one energy storage device, which is supplied from the rectified mains AC voltage and contains a winding of an inductor in series with a capacitor, is connected via a rectifier or a Zener diode to an output of the rectifier circuit.

The German patent publication DE 195 235 76 A1 describes an AC-DC power supply and a method for converting an AC voltage into a DC voltage in high voltage systems. The AC-DC power supply unit described there includes a semiconductor switch which is mounted on the low voltage side of the flyback converter with a lower breakdown voltage. The lower breakdown voltage can be achieved by means of a shunt regulator that regulates a clamping voltage to the low voltage side of the switch.

FIG. 10 shows an exemplary depiction of an electrical drive comprising battery, intermediate circuit, inverter and motor.

An inverter UMR1 generates a rotary field from the battery voltage of a battery BR1 for a motor M. The battery BR1 comprises statically or variably interconnected cells Z1-Z2. Charging of the battery BR1 takes place via a separate circuit, which is not depicted and is connected to the intermediate circuit ZK1. The inverter UMR1 is passive in the charging state.

FIG. 11 shows an exemplary depiction of a charging device. The charging device comprises a network filter B1, a diode rectifier B2, a power factor correction filter B3, a first voltage intermediate circuit B4, a transformer bridge circuit B5, a second voltage intermediate circuit B6 and an output B7.

The present invention provides a control device for charging an electrical energy store, comprising: a network filter device, which is designed to limit electrical interferences of an input AC voltage; a power rectifier circuit device, which is coupled to the network filter device and is designed to convert the input AC voltage into a rectified input voltage; a full bridge device which is coupled to the power rectifier circuit device and is designed to convert the rectified input voltage into a high-frequency AC voltage; a transformer device, which is coupled to the full bridge device and is designed to convert the high-frequency AC voltage into a transformed AC voltage; a rectifier circuit device which is coupled to the transformer device and is designed to convert the transformed AC voltage into a rectified output voltage; and an output choke which is coupled to the rectifier circuit device and is designed to filter the rectified output voltage in order, thereby, to charge the electrical energy store.

The present invention furthermore provides a method for charging an electrical energy store, comprising the following procedural steps: converting an input AC voltage into a rectified input voltage and converting the rectified input voltage into a high-frequency AC voltage; transforming the high-frequency AC voltage into a transformed AC voltage and converting the transformed AC voltage into a rectified output voltage; and filtering the rectified output voltage.

### SUMMARY OF THE INVENTION

In comparison to a normal charging device, the stated invention offers the advantage that neither the rectified mains voltage nor the rectified output voltage have to be smoothed.

As a result, large, expensive capacitors are no longer necessary. By eliminating large, expensive capacitors, the service life of the charging device is also increased.

By eliminating said capacitors, an inrush current limiting circuit as well as a discharge circuit for ensuring the high voltage safety of the charging device are therefore no longer necessary.

A further advantage of the invention is that no additional power factor correction filter, in abbreviated form PFC, is required. The charging current is controlled such that the charging current follows the input voltage.

As a result, the present invention offers cost and installation space advantages in relation to a normal charging device. By eliminating said large capacitors, an advantage also occurs with regard to the service life of the control device.

The transformer device provides galvanic isolation and converts the voltage in accordance with the requirements by means of the transformation ratio thereof The output voltage of the transformer device is subsequently rectified. The output choke serves to decouple from the direct converter, abbreviated form DICO, or to decouple from the direct inverter, abbreviated form DINV.

A concept of the present invention is that the charging current of the energy store is adjusted accordingly by means of the countervoltage of the direct inverter or of the direct converter.

According to an advantageous embodiment of the invention, provision is made for the network filter device to be designed as a lowpass filter. This advantageously allows electrical interferences from electronic devices into the current supply network as well as electrical interferences from the power supply network into the electronic devices to be limited.

According to a further embodiment of the invention, provision is made for the power rectifier circuit device to be designed as an uncontrolled rectifier comprising a plurality of semiconductor diodes.

According to a further advantageous embodiment of the invention, provision is made for the full bridge device to be designed as a bridge circuit.

According to a further advantageous embodiment of the invention, provision is made for the transformer device to be designed as a toroidal transformer or as a planar transformer or as another type of transformer. This allows the transformer device to be integrated in a space saving manner.

According to further advantageous embodiment of the invention, provision is made for the rectifier circuit device to be designed as an uncontrolled rectifier comprising a plurality of semiconductor diodes. This advantageously allows for the rectification of the output voltage to be carried out cost effectively and for the filter complexity to be reduced.

According to a further advantageous embodiment of the invention, provision is made for the output choke to be designed as an air-core coil or as another type of coil. This advantageously allows for a filtering of the output voltage to be achieved.

The aforementioned embodiments and modifications can be combined arbitrarily with each other, provided that such combinations are useful. Further possible embodiments, modifications and implementations of the invention also do not have to explicitly comprise named combinations of the features which were previously described or will be subsequently described with regard to the exemplary embodiments.

The person skilled in the art will also particularly add individual aspects as improvements or additions to the respective base form of the present invention.

### BRIEF DESCRIPTION OF THE DRAWINGS

Further features and advantages of embodiments of the invention ensue from the following description with reference to the attached drawings.

In the drawings:

FIG. 1 shows a schematic depiction of a control device for charging an electrical energy store according to one embodiment of the invention;

FIG. 2 shows a schematic depiction of a diagram of a temporal voltage profile of an input voltage according to a further embodiment of the invention;

FIG. 3 shows a schematic depiction of a diagram of a temporal voltage profile of a rectified input voltage according to a further embodiment of the invention;

FIG. 4 shows a schematic depiction of a diagram of a temporal voltage profile of a high-frequency AC voltage according to a further embodiment of the invention;

FIG. 5 shows a schematic depiction of a diagram of a temporal voltage profile of a rectified output voltage according to a further embodiment of the invention;

FIG. 6 shows a schematic depiction of a diagram of a temporal current profile of a charging current according to a further embodiment of the invention;

FIG. 7 shows a schematic depiction of a diagram of a temporal current profile of a countervoltage according to a further embodiment of the invention;

FIG. 8 shows a schematic depiction of an integrated inverter comprising a direct converter according to a further embodiment of the invention;

FIG. 9 shows a schematic depiction of a flow diagram of a method for charging an electrical energy store according to one embodiment of the invention;

FIG. 10 shows an exemplary depiction of an electrical output side comprising battery, intermediate circuit, converter and motor; and

FIG. 11 shows and exemplary depiction of a charging device.

### DETAILED DESCRIPTION

Identical or, respectively, functionally identical elements and devices provided nothing else is indicated are provided with the same reference signs in all of the figures.

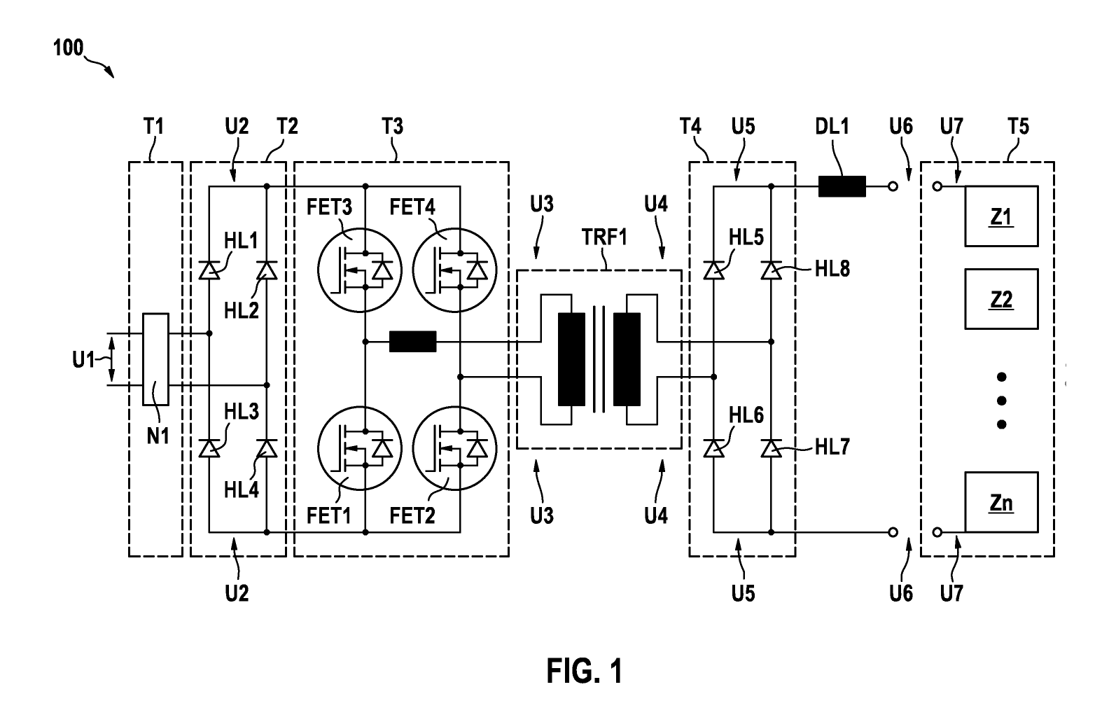

FIG. 1 shows a schematic depiction of a control device for charging an electrical energy store according to one embodiment of the invention.

A control device 100 for charging an electrical energy store T5 comprises a network filter device T1, a power rectifier circuit device T2, a full bridge device T3, a transformer device TRF1, a rectifier circuit device T4 and an output choke DL1.

The network filter device T1 comprises a network filter N1 in the present embodiment. The network filter device T1 is, for example, designed to limit electrical interferences of an input AC voltage U1. The network filter device T1 can thereby limit electrical interferences from electronic devices into the power supply network as well as electrical interferences from the power supply network into the electronic devices.

The power rectifier circuit device T2 is designed in the present case as an uncontrolled rectifier comprising a plurality of semiconductor diodes HL1-HL4. The power rectifier circuit device T2 is furthermore, for example, designed to convert the input AC voltage U1 into a rectified input voltage U2.

The full bridge device is, for example, designed as a bridge circuit and comprises a plurality of field effect transistors FET1-FET4. Instead of the field effect transistors FET1-FET4, other transistors of any design can also be used.

The transformer device TRF1 is, for example, designed to convert the high-frequency AC voltage U3 into a transformed AC voltage U4. The transformer device TRF1 is, for example, designed as a toroidal transformer or as a planar transformer.

The rectifier circuit device T4 is designed in the present case to convert the transformed AC voltage U4 into a rectified output voltage U5. The rectifier circuit device T4 comprises in the present embodiment a plurality of semiconductor diodes HL5-HL8.

The output choke DL1 is, for example, designed to filter the high-frequency portions of the rectified output voltage U5 in order, thereby, to charge the electrical energy store T5.

The electrical energy store T5 comprises at least one cell module Z1-Zn. As a result, the direct converter of the electrical energy store T5 actively interconnects a specific number of cell modules Z1-Zn as a function of a charging voltage U6 applied to said electrical energy store T5 in order, in accordance with the charging voltage U6, to generate a countervoltage U7 that is advantageous for the charging of said electrical energy store. For example, three cell modules Z1-Z3 are internally connected in series at an applied charging voltage U6 of 63.3 V, wherein each cell module has a cellular voltage of 20 V. When a charging voltage of 43.3 V is applied, two cell modules Z1-Z3 are internally connected in series. In addition, the direct converter can switch the cell modules Z1-Zn on and off in a predetermined order in order to ensure a uniform charging of the electrical energy store T5. In so doing, the switching operations of the direct converter can take place within time spans in the millisecond or microsecond range.

The electrical energy store T5 is, for example, designed as a cell module composite comprising a plurality of lithium-ion batteries, a plurality of capacitors, a plurality of lithium-polymer batteries, a plurality of lithium-titanate batteries, a plurality of lithium-manganese batteries or a plurality of lithium-iron phosphate batteries, or comprising a plurality of other types of batteries or electrical energy stores.

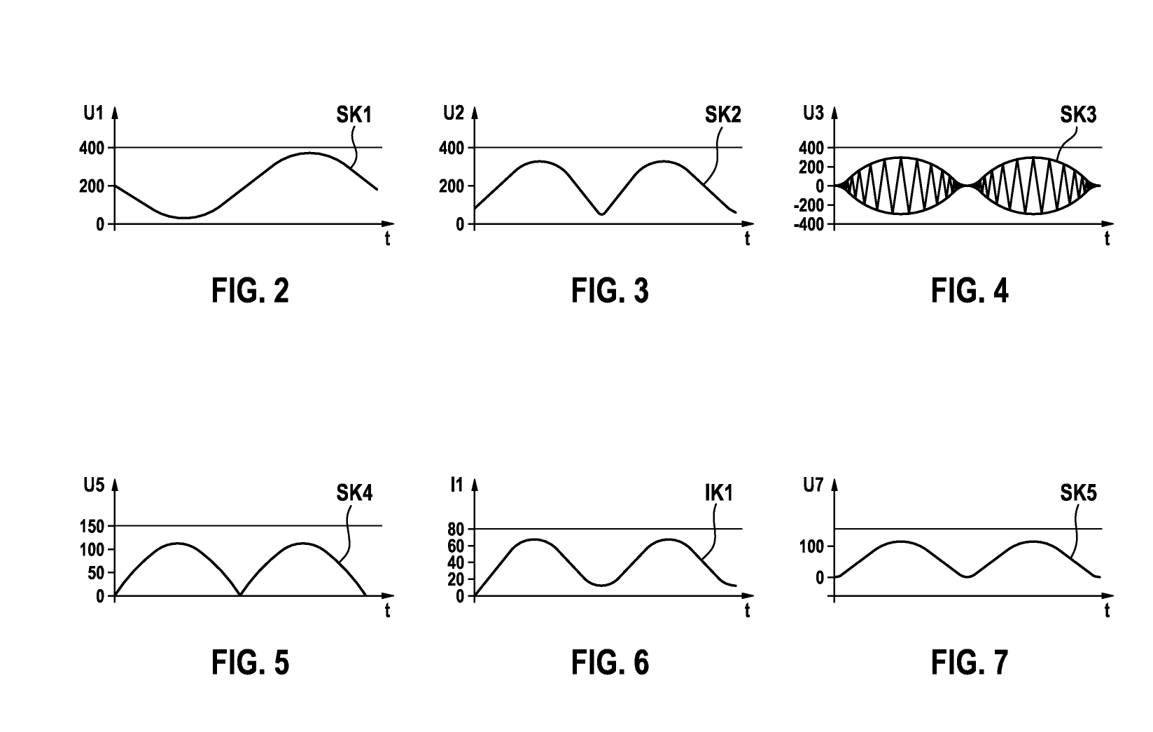

FIG. 2 shows a schematic depiction of a diagram of a temporal voltage profile of an input voltage according to a further embodiment of the invention.

The ordinate axis of the time diagram depicted in FIG. 2 depicts the amplitude of the input

AC voltage U1 in volts. The time t is plotted on the abscissa axis.

A voltage characteristic curve SK1 is depicted in the diagram shown in FIG. 2 and represents the temporal profile of the input AC voltage U1.

FIG. 3 shows a schematic depiction of a diagram of a temporal voltage profile of a rectified input voltage according to a further embodiment of the invention.

The ordinate axis of the time diagram depicted in FIG. 3 depicts the amplitude of the rectified input voltage in volts. The time t is plotted on the abscissa axis.

A voltage characteristic curve SK2 is depicted in the diagram shown in FIG. 3 and reflects the temporal profile of the rectified input voltage U2.

FIG. 4 shows a schematic depiction of a diagram of a temporal voltage profile of a high-frequency AC voltage according to a further embodiment of the invention.

The ordinate axis of the time diagram depicted in FIG. 4 represents the amplitude of a high-frequency AC voltage U3 in volts. The time t is plotted on the abscissa axis.

A voltage characteristic curve SK3 is depicted in the diagram shown in FIG. 4 and reflects the temporal profile of the high-frequency AC voltage U3.

FIG. 5 shows a schematic depiction of a diagram of a temporal voltage profile of a rectified output voltage according to a further embodiment of the invention.

The ordinate axis of the time diagram depicted in FIG. 5 represents the amplitude of a rectified output voltage A5 in volts. The time t is plotted on the abscissa axis.

A voltage characteristic curve SK4 is depicted in the diagram depicted in FIG. 5 and reflects the temporal profile of the rectified output voltage U5.

FIG. 6 shows a schematic depiction of a diagram of a temporal current profile of a charging current according to a further embodiment of the invention.

The ordinate axis of the time diagram depicted in FIG. 6 represents the amplitude of a charging current in the unit A. The time t is plotted on the abscissa axis.

A current characteristic curve IK1 is depicted in the diagram shown in FIG. 5 and reflects the temporal profile of a charging current I1 corresponding to the rectified output voltage U5.

FIG. 7 shows a schematic depiction of a diagram of a temporal voltage profile of a countervoltage according to a further embodiment of the invention.

The ordinate axis of the time diagram depicted in FIG. 7 represents the amplitude of a countervoltage U7 in volts. The time t is plotted on the abscissa axis.

A voltage characteristic curve SK5 is depicted in the diagram shown in FIG. 7 and reflects the temporal profile of the countervoltage U7.

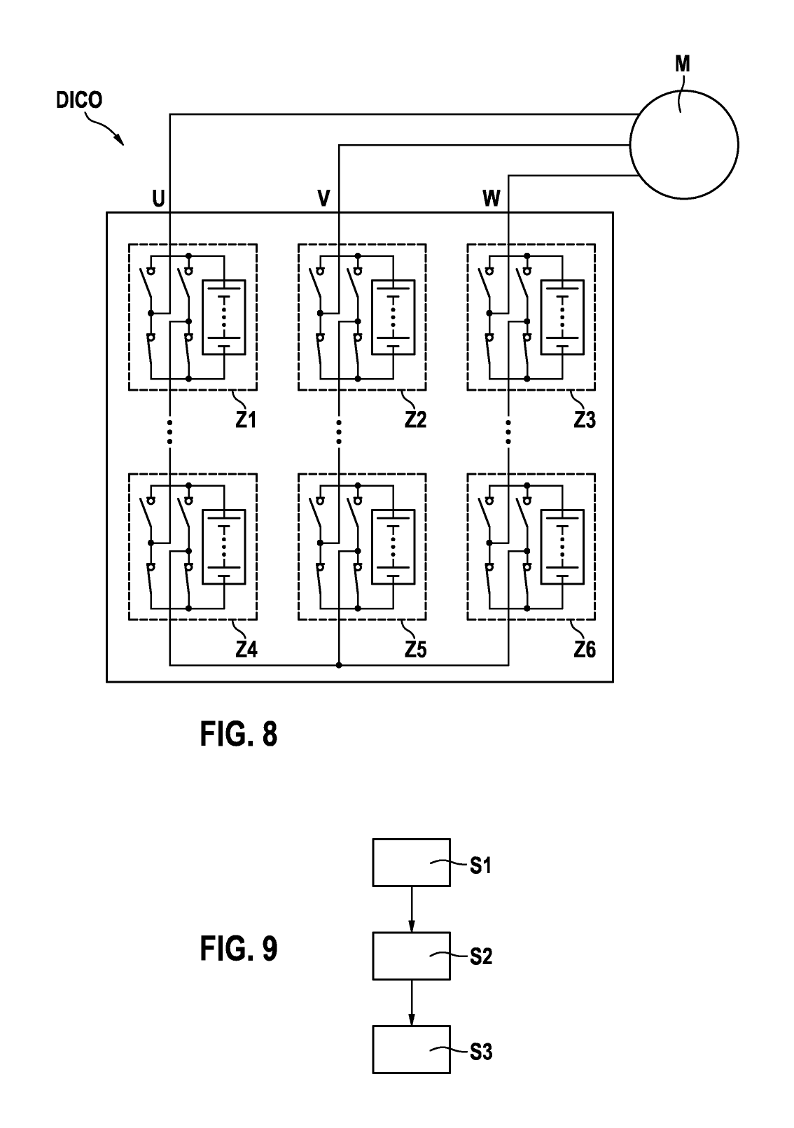

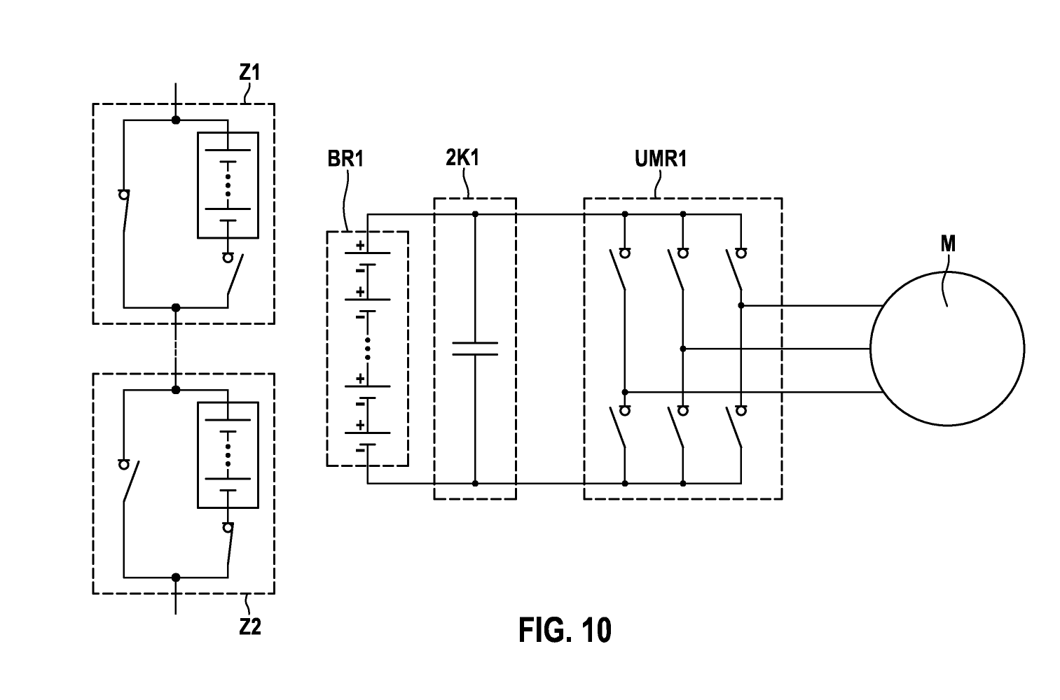

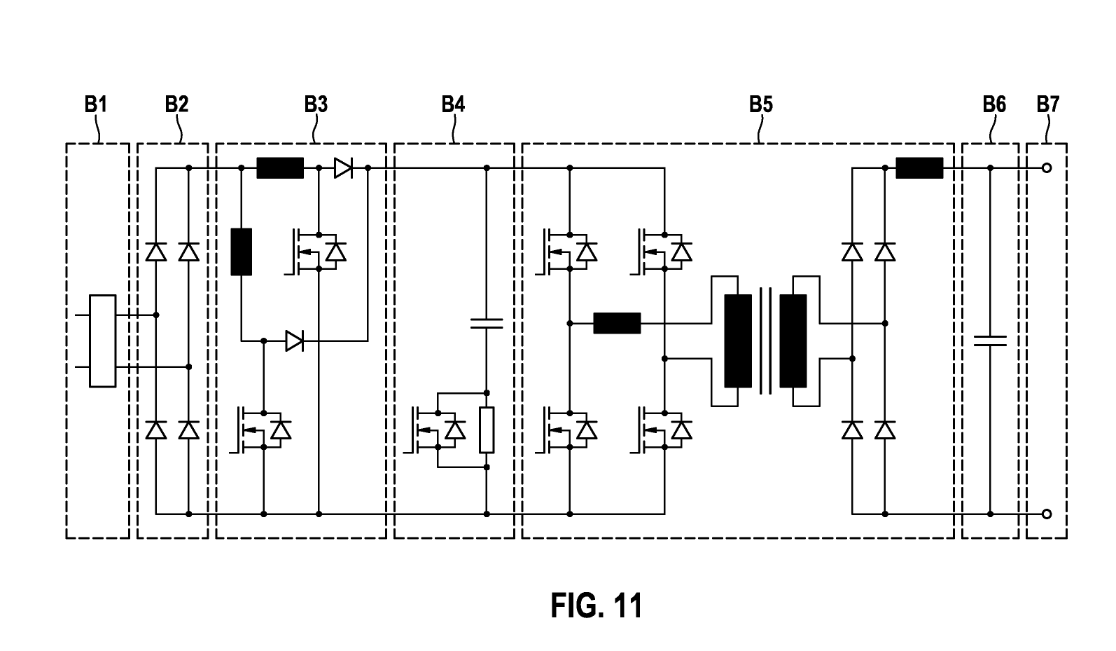

FIG. 8 shows a schematic depiction of an integrated inverter comprising a direct converter according to a further embodiment of the invention.

By means of a controlled interconnection of individual cell modules Z1-Z6, the integrated inverter DICO comprising a direct converter enables the rotary field to be directly generated with a predetermined amplitude and a predetermined frequency for the motor. In the design of the integrated inverter DICO, a variable intermediate circuit voltage is generated. This design also requires a charging circuit, such as the control device 100 for charging the electrical energy store T5.

FIG. 9 shows a schematic depiction of a flow diagram of a method for charging an electrical energy store according to an embodiment of the invention.

The method for charging the electrical energy store T5 comprising a direct converter is, for example, carried out by the control device 100.

A conversion S1 of an input AC voltage U1 into a rectified input voltage U2 and a conversion of the rectified input voltage U2 into a high-frequency AC voltage U3 takes place in a first step of the method.

A transformation S2 of the high-frequency AC voltage U3 into a transformed AC voltage U4 and a conversion of the transformed AC voltage U4 into a rectified output voltage U5 takes place in a second step of the method.

A filtering S3 of the rectified output voltage U5 takes place in a third step of the method.

Although the present invention was described above using preferred exemplary embodiments, the invention is not limited to said preferred exemplary embodiments but can be modified in a variety of ways. In particular, the invention can be changed or modified in various ways without deviating from the gist of the invention.

1. A control device for charging an electrical energy store, the control device comprising:
a network filter device, which is designed to limit electrical interferences of an input AC voltage;
a power rectifier circuit device, which is coupled to the network filter device and is designed to convert the input AC voltage into a rectified input voltage;
a full bridge device which is coupled to the power rectifier circuit device and is designed to convert the rectified input voltage into a high-frequency AC voltage;
a transformer device, which is coupled to the full bridge device and is designed to convert the high-frequency AC voltage into a transformed AC voltage;
a rectifier circuit device which is coupled to the transformer device and is designed to convert the transformed AC voltage into a rectified output voltage; and
an output choke which is coupled to the rectifier circuit device and is designed to filter the rectified output voltage, in order, thereby, to charge the electrical energy store.

2. The control device according to claim 1, wherein the network filter device is designed as a low-pass filter.

3. The control device according to claim 1, wherein the power rectifier circuit device is designed as an uncontrolled rectifier comprising a plurality of semiconductor diodes.

4. The control device according to claim 1, wherein the full bridge device is designed as a bridge circuit.

5. The control device according to claim 1, wherein the transformer device is designed as a toroidal transformer or as a planar transformer.

6. The control device according to claim 1, wherein the rectifier circuit device is designed as an uncontrolled rectifier comprising a plurality of semiconductor diodes.

7. The control device according to claim 1, wherein the output choke is designed as a coil comprising at least one magnetizable core.

8. A method for charging an electrical energy store, the method comprising:
converting an input AC voltage into a rectified input voltage and converting the rectified input voltage into a high-frequency AC voltage;
transforming the high-frequency AC voltage into a transformed AC voltage and converting the transformed AC voltage into a rectified output voltage; and
filtering the rectified output voltage.
